(19) United States
(12) Patent Application Publication
(10) Pub. No.: US 2007/0072067 A1
(43) Pub. Date: Mar. 29, 2007

(54) Vanadium redox battery cell stack

(75) Inventors: Peter G. Symons, Williamsville, NY (US); J. David Genders, Elma, NY (US); Timothy David John Hennessy, Portland, OR (US)

Correspondence Address: STOEL RIVES LLP, One Utah Center Suite 1100, 201 S Main Street, Salt Lake City, UT, 84111, US

(73) Assignee: VRB Power Systems Inc., Vancouver (CA)

(21) Appl. No.: 11/234,778

(22) Filed: Sep. 23, 2005

(51) Int. Cl. H01M 6/24; H01M 8/20; H01M 6/42

(52) U.S. Cl. 429/101; 429/105; 429/149

(57) ABSTRACT

A vanadium redox battery energy storage system is disclosed. The system may include a battery cell stack having at least one cell having a catholyte solution, a positive electrode in communication with the catholyte solution, an anolyte solution, a negative electrode in communication with the anolyte solution, and an anion exchange membrane separating the catholyte solution from the anolyte solution. Another cell in the cell stack includes a cation exchange membrane instead of an anion exchange membrane. A cell stack having a combination of cation and anion exchange membranes is configured to restrict net water shift, net vanadium transport and net change of proton and sulfate concentrations in the anolyte and catholyte solutions.

### TECHNICAL FIELD

The present disclosure relates to battery storage systems, and more specifically, to vanadium redox battery systems.

### BACKGROUND

Domestic and industrial electric power is generally provided by thermal, hydroelectric, and nuclear power plants. N/ew developments in hydroelectric power plants are capable of responding rapidly to power consumption fluctuations, and their outputs are generally controlled to respond to changes in power requirements. However, the number of hydroelectric power plants that can be built is limited to the number of prospective sites. Thermal and nuclear power plants are typically running at maximum or near maximum capacity. Excess power generated by these plants can be stored via pump-up storage power plants, but these require critical topographical conditions, and therefore, the number of prospective sites is determined by the available terrain.

New technological innovations and ever increasing demands in electrical consumption have made solar and wind power plants a viable option. Energy storage systems, such as rechargeable batteries, are an essential requirement for remote power systems that are supplied by wind turbine generators or photovoltaic arrays. Energy storage systems are further needed to enable energy arbitrage for selling and buying power during off peak conditions.

Vanadium redox energy storage systems have received favorable attention, as they promise to be inexpensive and possess many features that provide for long life, flexible design, high reliability, and low operation and maintenance costs. A vanadium redox energy storage system may include cells holding anolyte and catholyte solutions separated by a membrane. A vanadium redox energy storage system may also rely on a pumping flow system to pass the anolyte and catholyte solutions through the cells.

### BRIEF DESCRIPTION OF THE DRAWINGS

The present embodiments will become more fully apparent from the following description and appended claims, taken in conjunction with the accompanying drawings. Understanding that the accompanying drawings depict only typical embodiments, and are, therefore, not to be considered to be limiting of the invention's scope, the embodiments will be described and explained with specificity and detail in reference to the accompanying drawings in which:

FIG. 1 is a block diagram of an embodiment of a vanadium redox battery energy storage system;

FIG. 2 is a block diagram of an embodiment of a vanadium redox battery cell stack; and

FIG. 3 is a plan view of another embodiment of a vanadium redox battery energy storage system.

### DETAILED DESCRIPTION OF PREFERRED EMBODIMENTS

It will be readily understood that the components of the embodiments as generally described and illustrated in the Figures herein could be arranged and designed in a wide variety of different configurations. Thus, the following more detailed description of various embodiments, as represented in the Figures, is not intended to limit the scope of the invention, as claimed, but is merely representative of various embodiments. While the various aspects of the embodiments are presented in drawings, the drawings are not necessarily drawn to scale unless specifically indicated.

The phrases “connected to,” “coupled to” and “in communication with” refer to any form of interaction between two or more entities, including mechanical, electrical, magnetic, electromagnetic, fluid, and thermal interaction. Two components may be coupled to each other even though they are not in direct contact with each other. The term “abutting” refers to items that are in direct physical contact with each other, although the items may not necessarily be attached together.

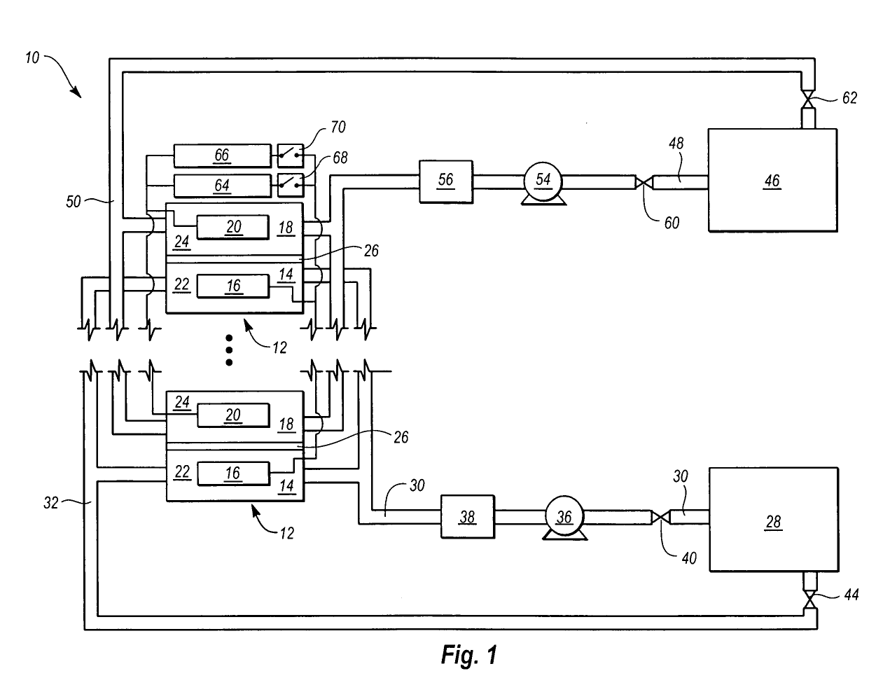

FIG. 1 is a block diagram of a vanadium redox battery energy storage system 10, hereinafter referred to as “VRB-ESS.” The system 10 includes a plurality of cells 12 that may each have a negative compartment 14 with a negative electrode 16 and a positive compartment 18 with a positive electrode 20. Suitable electrodes include any number of components known in the art and may include electrodes manufactured in accordance with the teachings of U.S. Pat. No. 5,665,212, which is hereby incorporated by reference. The negative compartment 14 may include an anolyte solution 22 in electrical communication with the negative electrode 16. The anolyte solution 22 may be an electrolyte containing specified redox ions which are in a reduced state and are to be oxidized during the discharge process of the cell 12, or are in an oxidized state and are to be reduced during the charging process of the cell 12, or which are a mixture of these latter reduced ions and ions to be reduced. By way of example, in a VRB-ESS 10 the charge-discharge redox reaction occurring at the negative electrode 16 in the anolyte solution 22 is represented by Equation 1.1:
V²⁺ [symbol] V³⁺+e⁻ Eq. 1.1

The positive compartment 18 contains a catholyte solution 24 in electrical communication with the positive electrode 20. The catholyte solution 24 may be an electrolyte containing specified redox ions which are in an oxidized state and are to be reduced during the discharge process of a cell 12, or are in a reduced state and are to be oxidized during the charging process of the cell 12, or which are a mixture of these oxidized ions and ions to be oxidized. By way of example, in a VRB-ESS 10 the charge-discharge redox reaction occurring at the positive electrode 20 in the catholyte solution 24 is represented by Equation 1.2:
V⁴⁺ [symbol] V⁵⁺+e⁻ Eq. 1.2

The anolyte and catholyte solutions 22, 24 may be prepared in accordance with the teachings of U.S. Pat. Nos. 4,786,567, 6,143,443, 6,468,688, and 6,562,514, which are hereby incorporated by reference, or by other techniques known in the art. Typically, aqueous NaOH is not included within the scope of the anolyte solution 22, and aqueous HCl is typically not included within the scope of the catholyte solution 24. In one embodiment, the anolyte solution 22 is 1M to 6M H₂SO₄ and includes a stabilizing agent in an amount typically in the range of from 0.1 to 20 wt %, and the catholyte solution 24 may also be 1M to 6M H₂SO₄.

Each cell 12 includes an ionically conducting membrane 26 disposed between the positive and negative compartments 14, 18 and in contact with the catholyte and anolyte solutions 22, 24 to provide ionic communication therebetween. The membrane 26 serves as a proton exchange membrane and may include a carbon material which may or may not be purflomatorated.

Although the membrane 26 disposed between the anolyte solution 24 and the catholyte solution 22 is designed to prevent the transport of water, vanadium and sulfate ions, typically some amount of water, vanadium and sulfate transport occurs. Consequently, after a period of time, the cells 12 become imbalanced because water, vanadium and sulfate crossover. Each crossover typically occurs in one direction (i.e., from the anolyte solution 24 to the catholyte solution 22 or from the catholyte solution 22 to the anolyte solution 24 depending on what type of membrane is used). In order to balance the system 10, the catholyte and anolyte solutions 22, 24 may be mixed which completely discharges the battery system 10.

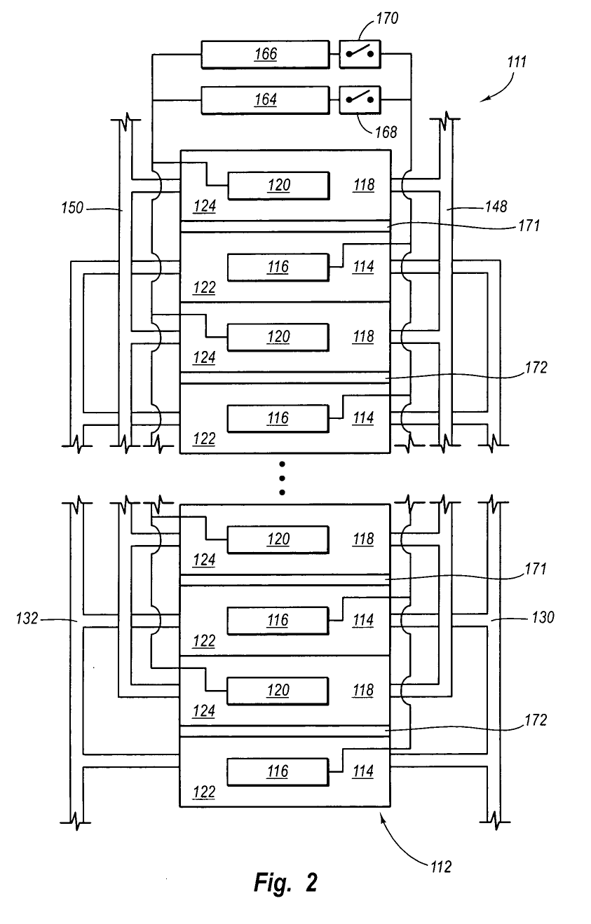

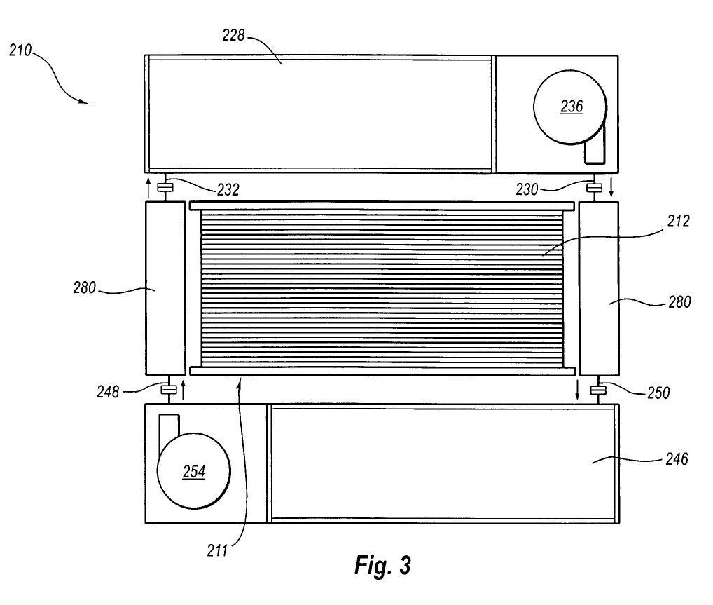

In conventional systems, the cells 12 in the cell stack are either all anion-selective membranes or all cation-selective membranes. Having all anion membranes or having all cation membranes results in unidirectional water transport and unidirectional vanadium transport. According to the embodiments described herein, at least one cell has an anion-selective membrane and at least one cell has a cation-selective membrane. The membrane configurations are discussed in greater detail in conjunction with the description accompanying FIGS. 2 and 3.

Additional anolyte solution 22 may be held in an anolyte reservoir 28 that is in fluid communication with the negative compartment 14 through an anolyte supply line 30 and an anolyte return line 32. The anolyte reservoir 28 may be embodied as a tank, bladder, or other container known in the art. The anolyte supply line 30 may communicate with a pump 36 and a heat exchanger 38. The pump 36 enables fluid movement of the anolyte solution 22 through the anolyte reservoir 28, supply line 30, negative compartment 14, and return line 32. The pump 36 may have a variable speed to allow variance in the generated flow rate. The heat exchanger 38 transfers heat generated from the anolyte solution 22 to a fluid or gas medium. The pump 36 and heat exchanger 38 may be selected from any number of suitable devices known to those having skill in the art.

The supply line 30 may include one or more supply line valves 40 to control the volumetric flow of anolyte solution. The return line 32 may also communicate with one or more return line valves 44 that control the return volumetric flow.

Similarly, additional catholyte solution 24 may be held in a catholyte reservoir 46 that is in fluid communication with the positive compartment 18 through a catholyte supply line 48 and a catholyte return line 50. The catholyte supply line 48 may communicate with a pump 54 and a heat exchanger 56. The pump 54 may be a variable speed pump 54 that enables flow of the catholyte solution 24 through the catholyte reservoir 46, supply line 48, positive compartment 18, and return line 50. The supply line 48 may also include a supply line valve 60, and the return line 50 may include a return line valve 62.

The negative and positive electrodes 16, 20 are in electrical communication with a power source 64 and a load 66. A power source switch 68 may be disposed in series between the power source 64 and each negative electrode 16. Likewise, a load switch 70 may be disposed in series between the load 66 and each negative electrode 16. One of skill in the art will appreciate that alternative circuit layouts are possible, and the embodiment of FIG. 1 is provided for illustrative purposes only.

In charging, the power source switch 68 is closed, and the load switch is opened. Pump 36 pumps the anolyte solution 22 through the negative compartment 14, and anolyte reservoir 28 via anolyte supply and return lines 30, 32. Simultaneously, pump 54 pumps the catholyte solution 24 through the positive compartment 18 and catholyte reservoir 46 via catholyte supply and return lines 48, 50. Each cell 12 is charged by delivering electrical energy from the power source 64 to negative and positive electrodes 16, 20. The electrical energy derives divalent vanadium ions in the anolyte solution 22 and quinvalent vanadium ions in the catholyte solution 24.

Electricity is drawn from each cell 12 by closing the load switch 70 and opening the power source switch 68. This causes the load 66, which is in electrical communication with negative and positive electrodes 16, 20 to withdraw electrical energy. Although not illustrated, a power conversion system may be incorporated to convert DC power to AC power as needed.

FIG. 2 is a block diagram of an embodiment of a vanadium redox battery cell stack 111 for use in a VRB-ESS. The cell stack 111 includes a plurality of cells 112 that each include a negative compartment 114 and a positive compartment 118. The negative compartment 114 includes a negative electrode 116 and the positive compartment 118 includes a positive electrode 120. The negative compartment 118 also includes an anolyte solution 122 as described in conjunction with FIG. 1, in electrical communication with the negative electrode 116. The positive compartment 116 includes a catholyte solution 124 that is in electrical communication with the positive electrode 120. The catholyte solution 124 is described in greater detail in conjunction with FIG. 1.

An anolyte supply line 130 may provide the negative compartment 114 with anolyte solution 122 from an anolyte reservoir (not shown in FIG. 2), and an anolyte return line 132 may return the anolyte solution 122 from the negative compartment 114 to the anolyte reservoir. Similarly, a catholyte supply line 148 may provide the positive compartment 118 with catholyte solution 124 from a catholyte reservoir (not shown in FIG. 2), and a catholyte return line 150 may return the catholyte solution 124 from the positive compartment 118 to the catholyte reservoir.

The negative and positive electrodes 116, 120 in the cell stack 111 are in electrical communication with a power source 164 and a load 166. By way of example, a power source switch 168 may be disposed in series between the power source 164 and each negative electrode 116. Likewise, a load switch 170 may be disposed in series between the load 166 and each negative electrode 116. In charging the cell stack 111, the power source switch 168 switch is closed, and the load switch 170 is opened. During a discharge process, electricity is drawn from each cell 112 by closing load switch 170 and opening power source switch 168.

Each cell 112 includes a membrane disposed between the positive and negative compartments 114, 118 and is in contact with the catholyte and anolyte solutions 122, 124 to provide ionic communication therebetween. One cell 112 of the cell stack 111 includes a cation membrane 171. The cation membrane 171 may be any commercially available cation exchange membrane such as a Nafion 115 membrane.

In the cell adjacent the cell containing the cation membrane 171, an anion membrane 172 may be disposed between the positive and negative compartments 114, 118 and is in contact with the catholyte and anolyte solutions 122, 124. The anion membrane 172 may be any type of commercially available anion exchange membrane as would be known to those having skill in the art.

In one embodiment, the cells 112 containing cation membranes 171 are alternated with cells 112 containing an anion membrane 172, such that each cell 112 having a cation membrane 171 is adjacent a cell 112 having an anion membrane 172, and each cell 112 having an anion membrane 172 is adjacent a cell 112 having a cation membrane 171. However, one having skill in the art would recognize that alternative configurations of cells 112 are envisioned. For example, the number of cation membrane-containing cells may not be equal to the number of anion membrane-containing cells, and/or the positioning of each may not be alternating as shown in the embodiment of FIG. 2. Furthermore, a cluster of anion membrane-containing cells may be included in the cell stack 111 along with a cluster of cation membrane-containing cells.

With cation exchange membranes 171, water crossover or transport across the membrane occurs in one direction, such as from the anolyte solution 122 across the membrane 171 to the catholyte solution 124. Furthermore, during the discharge process of the cell stack 111, vanadium ion transport across the cation membrane 171 typically occurs from the anolyte solution 122 to the catholyte solution 124 depending on factors such as electrolyte concentrations, pressure and current densities.

However, with anion exchange membranes 172, water transport across the membrane occurs in a second direction which is opposite from the cation membrane-containing cell. Additionally, vanadium transport across the anion membrane 172 typically occurs from the catholyte solution 124 to the anolyte solution 122 during the discharge process of the cell stack 111.

By having a combination of anion exchange membranes 172 and cation exchange membranes 171 in different cells 112, the net crossover of water in the cell stack 111 is improved. In one cell 112 the water transfer occurs in one direction (because it contains an anion membrane 172), and in another cell 112 water transport occurs in the opposite direction (because it contains a cation membrane 171). Thus over each cycle of the vanadium redox battery, there tends to be an improvement of efficiency and more balance than achieved in conventional systems.

This improvement in water management strategy in VRB-ESSs does not require the mixing of catholyte and anolyte solutions 124, 122 in order to balance the system which results in the discharge of the battery as is employed in conventional systems. This may be particularly beneficial in some applications, such as uninterruptible power supply (“UPS”) applications.

Additionally, by having a plurality of cells 112 containing a cation exchange membrane 171 and a plurality of cells 112 containing an anion exchange membrane 172, net vanadium transport between the catholyte solution 124 and the anolyte solution 122 is restricted. This results in an enhanced performance compared to conventional systems in terms of DC to DC efficiency evidenced by improved coulombic efficiency and reduced equalization losses.

Furthermore, a combination of cation exchange membranes 171 and anion exchange membranes 172 may result in a decrease in the overall change of proton and sulfate concentrations in the catholyte and anolyte solutions 124, 122. By way of example, a portion of the charge, proportional to the ratio of cation to anion membranes 171, 172, is supported by proton transport across the membrane from the catholyte solution 124 to the anolyte solution 122. Whereas the other portion of the charge in the other cells is supported by sulfate ions and is transported across the membrane from the anolyte solution 122 to the catholyte solution 122. Therefore, the change in ionic strength and conductivity is less than the entire charge supported by the transport of either proton or sulfate ions individually.

FIG. 3 represents another embodiment of a VRB-ESS 210 as shown from a plan view. The VRB-ESS 210 includes a cell stack 211 which contains a plurality of cells 212. Each cell 212 has a negative compartment with a negative electrode and a positive compartment with a positive electrode, as similarly described in conjunction with FIGS. 1 and 2. The negative compartment of the cell 212 contains anolyte solution while the positive compartment contains catholyte solution.

Each cell 212 includes an ionically conducting membrane disposed between positive and negative compartments. As heretofore described, a plurality of cells 212 contain a cation exchange membrane while the remaining plurality of cells 212 contain an anion exchange membrane. In some embodiments the cation membrane-containing cells are alternated with the anion membrane-containing cells. This improves water crossover and restricts net vanadium transport and net change of proton and sulfate concentrations.

According to the VRB-ESS 210 of FIG. 3, additional anolyte solution is held in an anolyte reservoir 228 that is in fluid communication with the negative compartments of the cells 212 in the cell stack 211 through an anolyte supply line 230 and an anolyte return line 232. The anolyte supply line 230 may be coupled to a pump 236 to enable fluid movement of the anolyte solution through the anolyte reservoir 228, supply line 230, negative compartment of each cell 212, and return line 232. The pump 236 may be a variable speed pump to allow variance in the generated flow rate.

Similarly, additional catholyte solution is held in a catholyte reservoir 246 that is in fluid communication with the positive compartment of each cell 212 through a catholyte supply line 248 and a catholyte return line 250. The catholyte supply line 248 may be coupled to a pump 254 that enables flow of the catholyte solution through the catholyte reservoir 246, supply line 248, positive compartment of each cell 212, and return line 250. As with the anolyte pump 236, the catholyte pump 254 may also be a variable speed pump to allow variance in the generated catholyte flow rate.

By way of example, a distributor 280 may be used to distribute the anolyte solution from the anolyte supply line 230 to the negative compartment of each cell 212. A distributor 280 may also be used to distribute the catholyte solution from the catholyte supply line 248 to the positive compartment of each cell 212. The distributors 280 may also provide the catholyte and anolyte solutions from the positive and negative compartments of each cell 212, respectively to the catholyte and anolyte return lines 250, 232.

Referring to FIGS. 1 through 3 generally, the present disclosure provides for a method for restricting net water and vanadium transport in a vanadium redox battery system. A vanadium redox battery cell stack 111, 211 having a plurality of cells 12, 112, 212 is provided. Each cell 12, 112, 212 has a catholyte solution 24, 124 and a positive electrode 20, 120 in communication with the catholyte solution 24, 124. Each cell 12, 112, 212 also has an anolyte solution 22, 122, a negative electrode 16, 116 in communication with the anolyte solution 22, 122, and a membrane 26 separating the catholyte solution 24, 124 and the anolyte solution 22, 122. The membrane 26 is either a cation exchange membrane 171 or an anion exchange membrane 172.

The membranes 26 in each cell 12, 112, 212 may be alternated so that each cell having a cation membrane 171 is adjacent a cell having an anion membrane 172 and each cell having an anion membrane 172 is adjacent a cell having a cation membrane 171. Water and vanadium transport across each anion exchange membrane 172 occurs in a direction from the anolyte solution 22, 122 toward the catholyte solution 24, 124 during a discharge process of the VRB-ESS 10, 210. Furthermore, water and vanadium transport across each cation exchange membrane 171 occurs in the opposite direction from the catholyte solution 24, 124 to the anolyte solution 22, 122.

A net change of proton and sulfate concentrations are also restricted in the anolyte 22, 122 and catholyte 24, 124 solutions. It should be apparent that each step or action of the methods described herein may be changed by those skilled in the art and still achieve the desired result. Thus, any order in the detailed description is for illustrative purposes only and is not meant to imply a required order.

It will be obvious to those having skill in the art that many changes may be made to the details of the above-described embodiments without departing from the underlying principles of the invention. The scope of the present invention should, therefore, be determined only by the following claims.

1. A cell stack in a battery energy storage system, comprising:
a first cell including:
a catholyte solution;
a positive electrode in communication with the catholyte solution;
an anolyte solution;
a negative electrode in communication with the anolyte solution; and
a cation membrane separating the catholyte solution and the anolyte solution;
and
a second cell including:
a catholyte solution;
a positive electrode in communication with the catholyte solution;
an anolyte solution;
a negative electrode in communication with the anolyte solution; and
an anion membrane separating the catholyte solution and the anolyte solution.

2. The cell stack of claim 1, wherein the cell stack is a vanadium redox battery cell stack.

3. The cell stack of claim 2, wherein the charge-discharge redox reaction occurring at the positive electrode in the catholyte solution is:
V⁴⁺ [symbol] V⁵⁺+e⁻; and
the charge-discharge redox reaction occurring at the negative electrode in the anolyte solution is:
V²⁺ [symbol] V³⁺+e⁻.

4. The cell stack of claim 1, wherein crossover of water across the cation membrane of the first cell occurs in a first direction and crossover of water across the anion membrane of the second cell occurs in a second direction opposite the first direction.

5. The cell stack of claim 4, wherein the first direction is from the anolyte solution to the catholyte solution during a discharge process of the battery energy storage system and the second direction is from the catholyte solution to the anolyte solution during the discharge process of the battery energy storage system.

6. The cell stack of claim 1, wherein the anion and cation membranes in combination are configured to restrict a net vanadium transport across membranes in the cell stack.

7. The cell stack of claim 1, wherein the anion and cation membranes in combination are configured to restrict a net change of proton and sulfate ion concentrations in the anolyte and catholyte solutions.

8. The cell stack of claim 1, further comprising:
a plurality of cells each including: a catholyte solution, a positive electrode in communication with the catholyte solution, an anolyte solution, a negative electrode in communication with the anolyte solution, and a cation membrane separating the catholyte solution and the anolyte solution; and
a plurality of cells each including: a catholyte solution, a positive electrode in communication with the catholyte solution, an anolyte solution, a negative electrode in communication with the anolyte solution, and an anion membrane separating the catholyte solution and the anolyte solution.

9. The cell stack of claim 8, wherein the cells are arranged in the cell stack such that each cell having a cation membrane is adjacent a cell having an anion membrane and each cell having an anion membrane is adjacent a cell having a cation membrane.

10. A rechargeable battery energy storage system, comprising:
a vanadium redox battery cell stack, including:
a first cell having a catholyte solution, a positive electrode in communication with the catholyte solution, an anolyte solution, a negative electrode in communication with the anolyte solution, and an anion membrane separating the catholyte solution and the anolyte solution; and
a second cell having a catholyte solution, a positive electrode in communication with the catholyte solution, an anolyte solution, a negative electrode in communication with the anolyte solution, and a cation membrane separating the catholyte solution and the anolyte solution;
an anolyte line coupled to the cell stack to carry anolyte solution;
an anolyte reservoir coupled to the anolyte line and having anolyte solution;
a catholyte line coupled to the cell stack to carry catholyte solution; and
a catholyte reservoir coupled to the catholyte line and having catholyte solution.

11. The battery energy storage system of claim 10, wherein the anion and cation membranes of the first and second cell in combination are configured to restrict net water shift between the catholyte solution and the anolyte solution.

12. The battery energy storage system of claim 11, wherein water shift across the anion membrane of the first cell occurs in a first direction and water shift across the cation membrane of the second cell occurs in a second direction opposite the first direction.

13. The battery energy storage system of claim 10, wherein the anion and cation membranes in combination are configured to restrict a net vanadium transport across membranes in the battery cell stack.

14. The battery energy storage system of claim 10, wherein the anion and cation membranes in combination are configured to restrict a net change of proton and sulfate ion concentrations in the anolyte and catholyte solutions.

15. The battery energy storage system of claim 10, wherein the vanadium redox battery cell stack further comprises:
a third cell having a catholyte solution, a positive electrode in communication with the catholyte solution, an anolyte solution, a negative electrode in communication with the anolyte solution, and an anion membrane separating the catholyte solution and the anolyte solution; and
a fourth cell having a catholyte solution, a positive electrode in communication with the catholyte solution, an anolyte solution, a negative electrode in communication with the anolyte solution, and a cation membrane separating the catholyte solution and the anolyte solution.

16. The battery energy storage system of claim 15, wherein the vanadium redox battery cell stack further comprises a plurality of cells having a catholyte solution, a positive electrode in communication with the catholyte solution, an anolyte solution, a negative electrode in communication with the anolyte solution, and a membrane separating the catholyte solution and the anolyte solution, such that the membrane in each cell of a first set of the plurality of cells is an anion membrane and the membrane in each cell of a second set of the plurality of cells is a cation membrane.

17. The battery energy storage system of claim 16, wherein the cell stack is arranged such that each cell having a cation membrane is adjacent a cell having an anion membrane and each cell having an anion membrane is adjacent a cell having a cation membrane.

18. A method for restricting net water and vanadium transport in a vanadium redox battery, comprising:
providing a vanadium redox battery cell stack having a plurality of cells, each cell having a catholyte solution, a positive electrode in communication with the catholyte solution, an anolyte solution, a negative electrode in communication with the anolyte solution, and a membrane separating the catholyte solution and the anolyte solution, such that each membrane is either a cation exchange membrane or an anion exchange membrane; and
alternating the membrane in each cell in the cell stack so that each cell having a cation membrane is adjacent a cell having an anion membrane and each cell having an anion membrane is adjacent a cell having a cation membrane;
wherein water and vanadium transport across each anion exchange membrane occurs in a first direction and water and vanadium transport across each cation exchange membrane occurs in a second direction opposite the first direction.

19. The method of claim 18, wherein the first direction is from the anolyte solution toward the catholyte solution during a discharge process of the vanadium redox battery and the second direction is from the catholyte solution toward the anolyte solution during the discharge process of the vanadium redox battery.

20. The method of claim 18, further comprising restricting a net change of proton and sulfate ion concentrations in the anolyte and catholyte solutions.
